(19) United States
(12) Patent Application Publication
(10) Pub. No.: US 2025/0317510 A1
(43) Pub. Date: Oct. 9, 2025

(54) DIALER CAPTURE COMMUNICATOR

(71) Applicant: The ADT Security Corporation, Boca Raton, FL (US)

(72) Inventor: Robert W. TAYLOR, Lakeland, FL (US)

(21) Appl. No.: 18/627,882

(22) Filed: Apr. 5, 2024

(51) Int. Cl. H04M 1/272; H04M 1/22

(52) U.S. Cl. CPC H04M 1/2725; H04M 1/22

(57) ABSTRACT

Dialer capture communicators are provided. In some embodiments, a dialer capture communicator is configured to receive an analog signal from the control device, the analog signal indicating an alarm event. The dialer capture communicator is configured to generate, using a DC-09 protocol, a digital message based on the analog signal. The dialer capture communicator is configured to cause transmission of the digital message to a remote server.

### TECHNICAL FIELD

The present technology is generally related to dialer capture communicators for premises monitoring systems.

### BACKGROUND

Premises monitoring systems can be used to monitor a premises for events that may trigger an alarm, such as unauthorized entry or presence of an emergency condition, such as fire. Some premises monitoring systems are able to send a message to a remote monitoring center relating to the triggering of an alarm.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings wherein:

FIG. 1 is a is a block diagram of an example premises according to some embodiments of the present disclosure;

FIG. 2 is a is a block diagram of an example of a dialer capture communicator according to some embodiments of the present disclosure;

FIG. 3 is a is a sequence diagram of example functionality performed by a premises monitoring system according to some embodiments of the present disclosure; and

FIG. 4 is a flowchart of example functionality performed by a dialer capture communicator according to some embodiments of the present disclosure.

### DETAILED DESCRIPTION

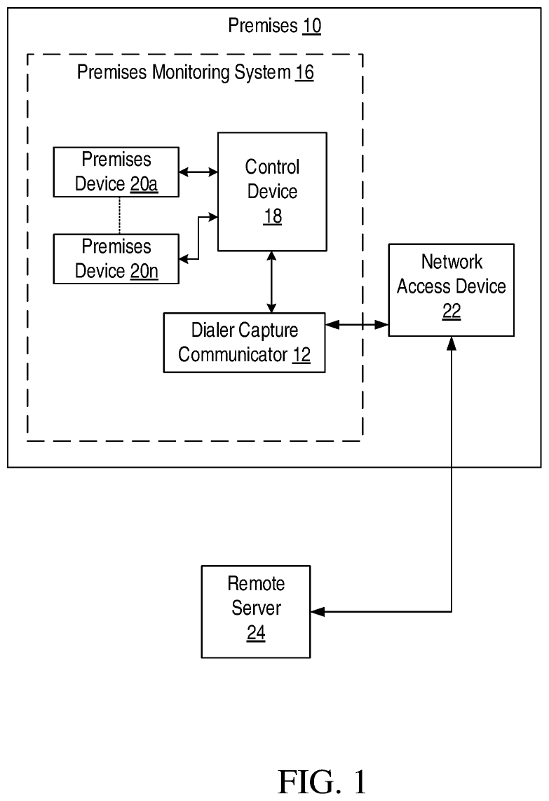

With reference to FIG. 1, there is shown a diagram of an example premises 10. A dialer capture communicator 12 is located at the premises 10 and may be part of a premises monitoring system 16 for monitoring the premises 10. The dialer capture communicator 12 may facilitate communication between remote monitoring hardware and a component of the premises monitoring system 16 that was designed to transmit and receive data using analog plain old telephone service (POTS) signals over telephone lines. As will be described in further detail below, dialer capture communicators 12 according to the present disclosure may translate between analog POTS signals and signals that comply with an open-source internet protocol (IP)-based security system event reporting protocol, such as the DC-09 digital communication protocol published by the Security Industry Association (SIA).

Premises monitoring system 16 may be configured to monitor various aspects of the premises 10. For example, premises monitoring system 16 may be used to detect burglaries, smoke, fires, carbon monoxide leaks, water leaks, etc. at the premises 10. Additionally, the premises monitoring functionality performed by premises monitoring system 16 may include home automation functionality. Examples of home automation functionality include thermostat control, door lock control, lighting control, appliance control, entertainment system control, etc.

The premises monitoring system 16 may include premises devices 20a-20n (collectively premises devices 20) for providing one or more of monitoring functionality, home automation functionality, etc. One or more of the premises devices 20 may be in communication with a control device 18 via one or more networks, such as, for example, a local area network at premises 10, such as a wireless network (e.g., WIFI, BLUETOOTH LOW ENERGY (BLE), ultra-wideband (UWB), ZIGBEE, Z-WAVE, among other Institute of Electrical and Electronics Engineers (IEEE) based short range wireless protocols, etc.).

A premises device 20 may include one or more sensors. For example, premises devices 20 may include motion sensors, fire sensors, smoke sensors, heat sensors, carbon monoxide sensors, flood sensors, flow sensors, temperature sensors, humidity sensors, proximity sensors, contact sensors, glass break sensors, water consumption sensors, water pressure sensors, etc. Additional examples of premises devices 20 include cameras, microphones, sirens, garage door controllers, smart doorbells (e.g., video doorbell camera configured to capture audio, images and/or video), temperature sensors, humidity sensors, lighting devices, switches, electrical outlets, electronic door locks, electrical plugs, etc.

Premises monitoring system 16 further comprises control device 18, which may be configured to provide control and monitoring functions according to various aspects of premises monitoring system 16. According to various embodiments, the control device 18 may be, or include, a wall-mountable panel device (e.g., a wall-mounted alarm system panel), a tabletop panel device (e.g., a tabletop alarm system panel), an alarm control panel having an enclosure and hinged door configured to be mounted in a closet, etc. Further, the control device 18 may have a short-range wireless communication radio that facilitates communication with one or more premises devices 20 and/or other devices via one or more short-range wireless communication protocols. Control device 18 may be configured to control and/or monitor premises devices 20, such as locks (e.g., electronic door locks), doors, windows, actuators, valves, motors, and any other controllable devices associated with premises monitoring system 16. According to various embodiments, control device 18 may be a gateway device, an alarm system panel, a hub and/or another type of device configured to control aspects of premises monitoring system 16. In some cases, the control device 18 may include hardware and software designed to communicate with a remote monitoring center using only analog POTS signals communicated through a public switched telephone network. For example, the control device 18 can be an obsolete alarm panel, or other type of control device 18, capable of communicating with a remote monitoring center using analog voiceband signals through a public switched telephone network but that lacks the hardware and/or software for communication using ethernet, cellular networks, satellite networks, and/or other communication technologies.

A network access device 22 may be located at the premises 10 and in communication with the dialer capture communicator 12. The network access device 22 may be a network access point for the dialer capture communicator 12 and/or other devices. According to various embodiments, a network access device 22 may be, e.g., a router, switch, hub, gateway, etc. The network access device 22 may communicate with the network access device 22 and/or other devices using wired and/or wireless communication protocols. For example, the network access device 22 may communicate with the dialer capture communicator 12 via one or more wireless protocols, including but not limited to Wi-Fi, BLE, UWB, ZIGBEE, Z-WAVE, among other IEEE based short range wireless protocols.

The network access device 22 may be in communication with a remote server 24, which may be located off the premises 10. The remote server 24 is representative of one or more remote computing systems that may communicate with the premises monitoring system 16 via the dialer capture communicator 12. The remote server 24 may also be configured to perform remote monitoring functionality for other premises monitoring systems 16 at other premises 10. The remote server 24 may receive and process signals, such as alarm event signals, sensor event signals, status signals, etc., received from premises monitoring systems 16. For example, the remote server 24 may provide information regarding one or more premises monitoring systems 16 to client devices, such as workstation computers, operated by human monitoring agents, who may communicate with personnel at a Public Safety Answering Pont (PSAP) to request the dispatch of police, fire department, or medical assistance to the premises 10 in the event of an alarm event.

The communication link between the network access device 22 and the remote server 24 may be provided by one or more networks such, for example, one or more intranets, extranets, wide area networks (WANs), local area networks (LANs), wired networks, wireless networks, satellite networks, Data Over Cable Service Interface Specification (DOCSIS) networks, cellular networks, POTS networks, and/or other types of networks. The one or more networks may support one or more communication protocols, one or more wired communication links, one or more wireless communication links, etc.

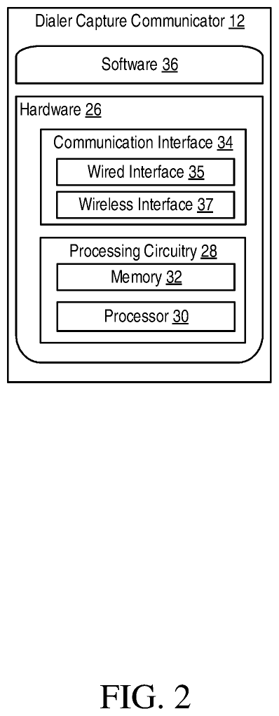

FIG. 2 shows a block diagram illustrating an example dialer capture communicator 12 according to one or more embodiments. The dialer capture communicator 12 comprises hardware 26, which may include processing circuitry 28. The processing circuitry 28 may include one or more processors 30 and one or more memories 32. Each processor 30 may include and/or be associated with one or more central processing units, data buses, buffers, and interfaces to facilitate operation. In addition to or instead of a processor 30 and memory 32, the processing circuitry 28 may comprise other types of integrated circuitry that perform various functionality. Integrated circuitry may include one or more processors 30, processor cores, field programmable gate arrays (FPGAs), application specific integrated circuits (ASICs), graphics processing units (GPUs), systems on chips (SoCs), or other components configured to execute instructions. The processor 30 may be configured to access (e.g., write to and/or read from) the memory 32, which may comprise any kind of volatile and/or nonvolatile memory, e.g., cache, buffer memory, random access memory (RAM), read-only memory (ROM), optical memory, and/or erasable programmable read-only memory (EPROM). Further, memory may be embodied in the form of one or more storage devices. The processing circuitry 28 may be configured to perform various functionality described herein. For example, computer instructions may be stored in memory 32 and/or another computer-readable medium that, when executed by processor 30 causes the processor 30 to perform various functionality described herein.

Hardware 26 may include communication interfaces 34 facilitating communication between dialer capture communicator 12 and one or more elements described above, including control device 18 and network access device 22. The communication interfaces 34 may include a control device interface 35 for communication with the control device 18. The control device interface 35 may be configured to transmit and receive analog voiceband signals, such as POTS signals, to and from the control device 18. Additionally, the control device interface 35 may include an RJ31X telephone jack, which may facilitate coupling the dialer capture communicator 12 to the control device 18 using a telephone cable with RJ11 connectors.

The communication interfaces 34 may further include a network access device interface 37 for communication with the network access device 22. The network access device interface 37 may be configured to transmit and receive signals that are compatible with the network access device 22, e.g., via Ethernet, Wi-Fi, BLE, UWB, ZIGBEE, Z-WAVE, among other protocols.

Dialer capture communicator 12 further has software 36 (which may include one or more software applications) stored internally in, for example, memory 32, or stored in external memory (e.g., database, storage array, network storage devices, etc.) accessible by the dialer capture communicator 12 via an external connection. Software 36 may include any software or program that configures processing circuitry 28 to perform the steps or processes of the present disclosure.

The processing circuitry 28 may be configured to control any of the methods and/or processes described herein and/or to cause such methods, and/or processes to be performed, e.g., by dialer capture communicator 12. Processor 30 corresponds to one or more processors 30 for performing dialer capture communicator 12 functions described herein. The memory 32 is configured to store data and/or files and/or other information/data. In some embodiments, the software 36 may include instructions that, when executed by the processor 30 and/or processing circuitry 28, causes the processor 30 and/or processing circuitry 28 to perform the processes described herein with respect to dialer capture communicator 12. Accordingly, by having computer instructions stored in memory 32 accessible to the processor 30, the processor 30 may be configured to perform the actions described herein.

As described above, the control device 18 may have hardware and/or software for communicating information, including but not limited to control device events (e.g., periodic timer tests, indications relating to power (such as low battery and/or a power failure), a change in state of the premises security system 16 (such as between armed and disarmed), and an alarm event (such the triggering of an alarm), to a remote monitoring center via only POTS signaling using POTS networks (e.g., public switched telephone networks). However, such a POTS connection may be subject to sunsetting by telecommunications providers, which may result in the control device 18 being unable to communicate with the remote monitoring center after the network becomes unavailable. Some techniques that may allow for such a control device 18 to communicate with the remote monitoring center after the POTS network has been retired include converting the POTS signaling and transmitting the signals using voice over IP (VOIP). However, communicating those signals using VOIP may involve compression, which may negatively affect the integrity of the information being communicated between the control device 18 and the remote monitoring center. Some other techniques that may allow a POTS-based control device 18 to communicate after the POTS network has been sunset may require the use of proprietary communication protocols and/or hardware, such as proprietary signal receivers and/or line cards, which can be costly.

Embodiments of the present disclosure may overcome those drawbacks and (i) allow continued use of POTS-based control devices 18 after POTS networks have been phased out; (ii) avoid using VOIP for communicating signals for premises monitoring systems 16; and (iii) avoid use of costly proprietary monitoring center hardware. In particular, dialer capture communicators 12 of the present disclosure may act as an intermediary between the control device 18 and the remote server 24 and use an open-source IP-based security system event reporting protocol, such as the SIA DC-09 protocol, to communicate with remote monitoring centers.

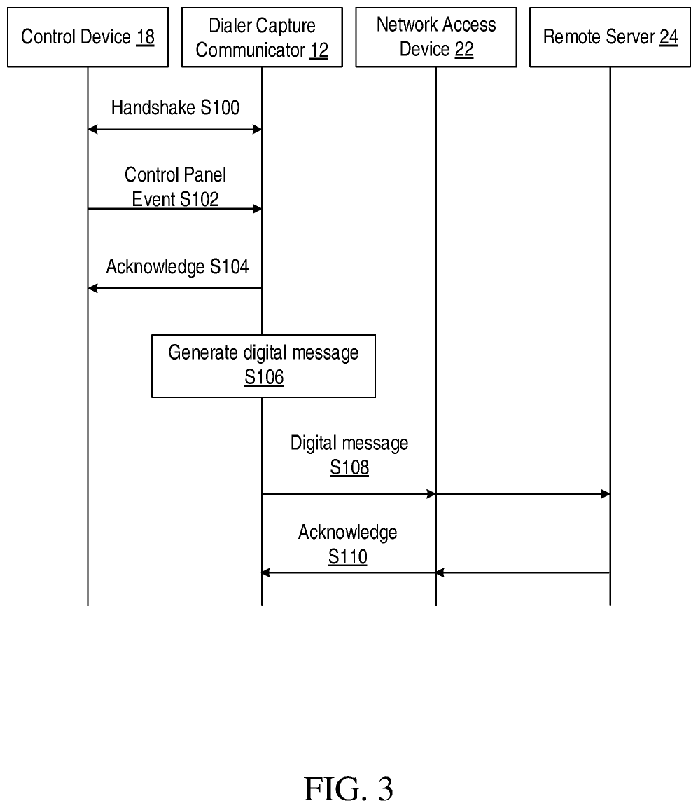

With reference to FIG. 3, shown is a sequence diagram depicting an example of communications between the control device 18, the dialer capture communicator 12, the network access device 22, and the remote server 24. Beginning at Block S100, when connected to the control device 18, the dialer capture communicator 12 may perform a handshake procedure (Block S100). The handshake procedure may include, e.g., providing a simulated dial tone to allow the control device 18 to transmit messages (e.g., regarding control panel events) in, e.g., ContactID and/or one or more communication formats, such as those described by specifications of the SIA. By the dialer capture communicator 12 providing a simulated dial tone, it may appear to the control device 18 that a telephone connection to a telephone network is available for communication. In response to the simulated dial tone, the control device 18 may transmit information using POTS signaling, which the dialer capture communicator 12 may receive and answer using handshake tones.

The dialer capture communicator 12 receives a signal, e.g., an analog signal, from the control device 18 that indicates a control panel event (Block S102). The dialer capture communicator 12 converts the analog signal to a digital message (Block S106). The digital message may be according to one or more specifications, including but not limited to an open-source specification, such as SIA specification DC-09. Advantages of conversion from the analog signal to the digital message at the premises 10 may include avoiding complications of incompatible codecs in telecommunication transmission networks. In addition, use of an open-source IP-based security system event protocol, such as that specified by SIA DC-09, may mean the remote server 24 does not have to rely on a proprietary communication format. The digital message may comprise data representing a time of occurrence (which may be referred to as “attribute H”) that corresponds to a time when the dialer capture communicator 12 received a communication from the control device 18.

The dialer capture communicator 12 may be connected to a network access device 22 at the premises 10 via, e.g., a wireless or wired connection as described above. The dialer capture communicator 12 transmits the digital message to the network access device 22 for forwarding of the digital message to the remote server 24 (Block S108). The remote server 24 transmits an acknowledgement message to the dialer capture communicator 12 via the network access device 22 (Block S110).

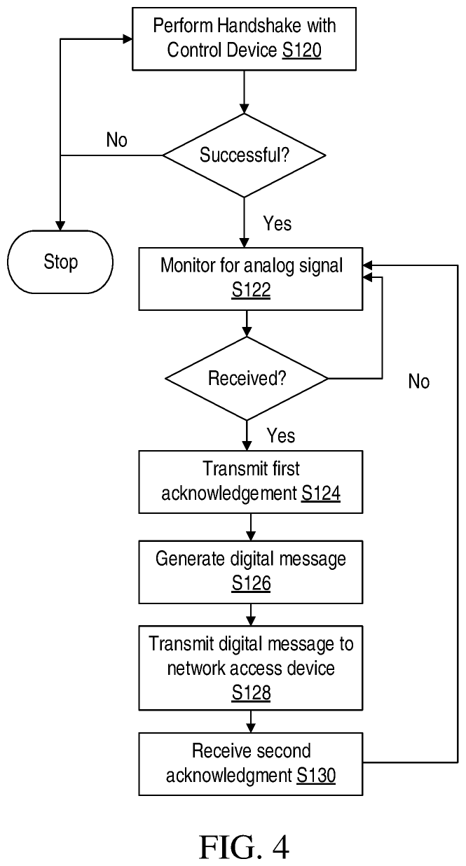

FIG. 4 is a flowchart of an example process implemented by dialer capture communicator 12 (including by one or more of processing circuitry 28, and processor 30) according to some embodiments of the present disclosure. Dialer capture communicator 12 is configured to perform a handshake procedure with the control device 18 (Block S120). If the procedure is unsuccessful, it may be repeated, or the process may stop. If the handshake procedure is successful, the dialer capture communicator 12 monitors for receiving an analog signal from the control device 18 (Block S122). If no analog signal is received, the dialer capture communicator 12 continues to monitor. Once the analog signal is received, the dialer capture communicator 12 transmits a first acknowledgment to the control device 18 (Block S124). The dialer capture communicator 12 then generates a digital message corresponding to the analog signal (Block S126). The dialer capture communicator 12 transmits the digital message to the network access device 22 for transmission to the remote server 24 (Block S128). The dialer capture communicator 12 then receives a second acknowledgement message from the network access device 22 indicating that the message was received by the remote server 24 (Block S130). The dialer capture communicator 12 may then continue to monitor for further analog signals by repeating Block S122.

The concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects. Any process, step, action and/or functionality described herein may be performed by, and/or associated to, a corresponding module and/or unit, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. Each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

In addition, unless mention was made above to the contrary, the accompanying drawings are not to scale. A variety of modifications and variations are possible in light of the above teachings without departing from the scope and spirit of the present disclosure.

What is claimed is:

1. A dialer capture communicator configured to communicate with a network access device for a local area network at a premises and a control device of a premises security system for the premises, the dialer capture communicator comprising:
an RJ31X telephone jack;
at least one processor; and
at least one memory storing a plurality of instructions that, when executed by the at least one processor, cause the at least one processor to:
perform a handshake procedure with the control device using a simulated dial tone via a telephone line connection and the RJ31X telephone jack;
receive an analog signal from the control device, the analog signal indicating a control device event associated with the premises security system;
transmit, to the control device, a first acknowledgment message acknowledging the analog signal being received;
generate, using a DC-09 protocol, a digital message based on the analog signal;
wirelessly transmit the digital message to the network access device for transmission of the digital message to a remote server; and
receive, from the network access device, a second acknowledgement message indicating that the remote server received the digital message.

2. The dialer capture communicator of claim 1, wherein the digital message comprises data representing a time of occurrence corresponding to a time the dialer capture communicator received the analog signal.

3. A dialer capture communicator in communication with a control device of a premises security system, the dialer capture communicator comprising:
a wired communication interface;
at least one processor; and
at least one memory storing a plurality of instructions that, when executed by the at least one processor, cause the at least one processor to:
receive an analog signal from the control device via the wired communication interface, the analog signal indicating a control panel event;
generate, using a DC-09 protocol, a digital message based on the analog signal; and
cause transmission of the digital message to a remote server.

4. The dialer capture communicator of claim 3, wherein the plurality of instructions are further configured to cause the at least one processor to perform a handshake procedure with the control device.

5. The dialer capture communicator of claim 3, wherein the plurality of instructions are further configured to cause the at least one processor to transmit, to the control device, a first acknowledgment message acknowledging the receiving of the analog signal.

6. The dialer capture communicator of claim 3, wherein the plurality of instructions are further configured to cause the at least one processor to wirelessly transmit the digital message to a network access device for transmission of the digital message to the remote server.

7. The dialer capture communicator of claim 6, wherein the wireless transmission is a Wi-Fi transmission.

8. The dialer capture communicator of claim 3, wherein the plurality of instructions are further configured to cause the at least one processor to receive, from a network access device, a second acknowledgement message indicating that the remote server received the digital message.

9. The dialer capture communicator of claim 3, wherein the digital message comprises a time of occurrence corresponding to a time the dialer capture communicator received the analog signal.

10. The dialer capture communicator of claim 3, wherein the wired communication interface comprises a RJ31X telephone jack.

11. The dialer capture communicator of claim 3, wherein the control panel event comprises at least one of:
a periodic timer test;
a low battery indication;
a power failure indication;
a change in state of the premises security system; or
an alarm event.

12. A method implemented by a dialer capture communicator in communication with a control device of a premises security system, the method comprising:
receiving an analog signal from the control device via a wired communication interface, the analog signal indicating a control panel event;
generating, using a DC-09 protocol, a digital message based on the analog signal; and
causing transmission of the digital message to a remote server.

13. The method of claim 12, further comprising performing a handshake procedure with the control device.

14. The method of claim 12, further comprising transmitting, to the control device, a first acknowledgment message acknowledging the receiving of the analog signal.

15. The method of claim 12, further comprising wirelessly transmitting the digital message to a network access device for transmission of the digital message to the remote server.

16. The method of claim 15, wherein the wireless transmission is a Wi-Fi transmission.

17. The method of claim 12, further comprising receiving, from a network access device, a second acknowledgement message indicating that the remote server received the digital message.

18. The method of claim 12, wherein the digital message comprises a time of occurrence corresponding to a time the dialer capture communicator received the analog signal.

19. The method of claim 12, wherein the wired communication interface comprises a RJ31X telephone jack.

20. The method of claim 12, wherein the control panel event comprises at least one of:
a periodic timer test;
a low battery indication;
a power failure indication;
a change in state of the premises security system; or
an alarm event.
